(19) United States
(12) Patent Application Publication
(10) Pub. No.: US 2010/0282211 A1
(43) Pub. Date: Nov. 11, 2010

(54) FUEL DELIVERY SYSTEM

(75) Inventors: PATRICK DANIEL, BLOIS (FR); MARCOS PAGOTO, NANTES (FR)

Correspondence Address: DELPHI TECHNOLOGIES, INC, M/C 480-410-202, PO BOX 5052, TROY, MI, 48007, US

(73) Assignee: DELPHI TECHNOLOGIES, INC., TROY, MI (US)

(21) Appl. No.: 12/770,809

(22) Filed: Apr. 30, 2010

(30) Foreign Application Priority Data
May 6, 2009 (EP) 09159577.7

(51) Int. Cl. F02M 63/00; B05B 1/30; F02M 57/02

(52) U.S. Cl. 123/447; 239/584; 123/446

(57) ABSTRACT

A fuel delivery system for an internal combustion engine, the system comprising at least one fuel injector, said fuel injector comprising a control chamber having an inlet for receiving highly pressurised fuel and an outlet enabling fuel to flow out of the control chamber into a back-leak passage associated with the fuel injector, wherein the fuel injector is operable between an injecting state and a non-injecting state in dependence on the fuel pressure within the control chamber. The system further includes a pressure regulator for regulating the fuel pressure within the back-leak passage so as to maintain the injector back-leak pressure at a predetermined target value which is below atmospheric pressure.

### TECHNICAL FIELD

The present invention relates to a fuel delivery system for an internal combustion engine.

### BACKGROUND TO THE INVENTION

One type of known fuel injection system for a compression-ignition internal combustion engine (e.g. a diesel engine) comprises a high pressure pump, a common rail accumulator volume and a plurality of fuel injectors, each of which is associated with a respective combustion chamber of the engine.

The high pressure pump is arranged to receive fuel at low pressure from a fuel supply, such as a vehicle fuel tank, and to pump fuel at high pressure, e.g. 2000 bar, into the common rail. The common rail feeds each of the plurality of fuel injectors with fuel at high pressure.

Each of the plurality of fuel injectors may be a so-called servo-valve injector, as are generally known in the art. A servo-valve injector typically comprises a valve member which is moveable towards and away from a valve seating so as to control the injection of fuel through one or more injection holes. A control chamber is disposed at the back end of the valve member. The control chamber has an inlet for receiving fuel at high pressure from the common rail. The control chamber also has an outlet, via which fuel may flow out of the control chamber into a low pressure return path or back-leak passage.

The fuel pressure within the control chamber is controlled by means of a control valve, i.e. a servo-valve. The control valve is movable between a first position, in which fluid communication between the outlet of the control chamber and the back-leak passage is prevented, and a second position, in which fluid communication between the outlet of the control chamber and the back-leak passage is permitted.

A surface associated with the valve member is exposed to fuel pressure within the control chamber. Accordingly, movement of the valve member is determined by the fuel pressure within the control chamber. When the control valve is in the first position, the fuel pressure in the control chamber is high, and the valve member is biased against the valve seating into a non-injecting position. When the control valve moves into the second position, fuel flows out of the control chamber into the back-leak passage and the fuel pressure within the control chamber drops below the level required to maintain the valve member in the non-injecting state. Accordingly, the valve member lifts from the valve seating so as to enable fuel to be injected via the injection holes.

In the known servo-valve injector, parameters such as the duration of an injection event and the speed at which the valve member opens and closes at the beginning and end of an injection event are dependent upon the rate of change of the fuel pressure in the control chamber when the control valve is moved between the first and second positions. However, there are problems associated with accurately controlling the rate of change of fuel pressure in the control chamber, since it is affected by environmental and/or engine operating conditions. This, in turn, can adversely affect the operation of the fuel injector.

It is an object of the present invention to provide a fuel delivery system which substantially overcomes or mitigates the aforementioned problem.

### SUMMARY OF INVENTION

According to the present invention, there is provided a fuel delivery system for an internal combustion engine, the system comprising at least one fuel injector, said fuel injector comprising a control chamber having an inlet for receiving highly pressurised fuel and an outlet enabling fuel to flow out of the control chamber into a back-leak passage associated with the fuel injector, wherein the fuel injector is operable between an injecting state and a non-injecting state in dependence on the fuel pressure within the control chamber. The system further comprises pressure regulating means for regulating the fuel pressure within the back-leak passage so as to maintain the injector back-leak pressure at a predetermined target value which is below atmospheric pressure.

The system may comprise a high pressure pump and a common rail accumulator volume, wherein the high pressure pump is arranged, in use, to pump fuel at high pressure into said common rail, and said common rail is arranged to feed fuel at high pressure to the inlet of said at least one fuel injector, and wherein said high pressure pump comprises a venturi duct and said pressure regulating means is coupled to said venturi duct such that, in use, high pressure fuel is pumped through the venturi duct to a low pressure pump outlet, thereby reducing the fuel pressure in the back-leak passage below atmospheric pressure.

In one embodiment the pressure regulating means may comprise a hollow cylindrical body portion having an inlet which is in fluid communication with the back-leak passage, an outlet and a piston arranged for reciprocable movement within said body portion and being sealingly engaged therewith.

Preferably, the pressure regulating means also comprises a first volume defined between the piston and a first end wall of the body portion, and a second volume defined between the piston and a second end wall of the body portion wherein said outlet is spaced apart from said inlet in the direction of the primary axis of the body portion, said inlet being disposed proximal to said second end wall. Furthermore, when the pressure in the second volume is less than said target pressure, the piston is biased so as to move toward the second end wall and close the outlet, thereby restricting or preventing the flow of fuel through the outlet.

Conveniently, said first end wall comprises an opening so as to enable air at atmospheric pressure into the first volume. Alternatively, said first volume may be evacuated or filled with a gas having a relatively low coefficient of expansion e.g. nitrogen.

Advantageously, said pressure regulating means comprises biasing means for imparting a force on the piston in the direction of the primary axis of the body portion, tending to close the outlet.

Conveniently, said biasing means is disposed between the piston and one of said first end wall and said second end wall.

For convenience and cost-efficiency, the biasing means is a spring, although it may take other forms such as a gas-filled chamber, for example.

Said pressure regulating means may be formed integrally with each fuel injector, so that each fuel injector has its own dedicated pressure regulating means.

Alternatively, the system may comprise at least two fuel injectors, wherein said back-leak passage is associated with each of said at least two fuel injectors.

In a further aspect, the invention provides a method of controlling a fuel injector in a fuel delivery system for an internal combustion engine, the fuel injector comprising a control chamber having an inlet for receiving high pressure fuel and an outlet enabling fuel to flow out of the control chamber into a back-leak passage associated with the fuel injector, the method comprising: varying the fuel pressure in the control chamber to change a state of the fuel injector between an injecting state and a non-injecting state, and regulating the fuel pressure within the back-leak passage so as to maintain the injector back-leak pressure at a predetermined target value which is below atmospheric pressure.

### BRIEF DESCRIPTION OF DRAWINGS

The present invention will now be described with reference to embodiments, provided by way of example only, with reference to the accompanying drawings, in which;

FIG. 1 is a schematic view of a first embodiment of a fuel delivery system;

FIG. 2 shows a first embodiment of pressure regulating means suitable for use in the fuel delivery systems of FIGS. 1 and 4;

FIG. 3 shows a second embodiment of pressure regulating means suitable for use in the fuel delivery systems of FIGS. 1 and 4; and

FIG. 4 is a schematic view of a second embodiment of a fuel delivery system.

### DETAILED DESCRIPTION OF PREFERRED EMBODIMENTS

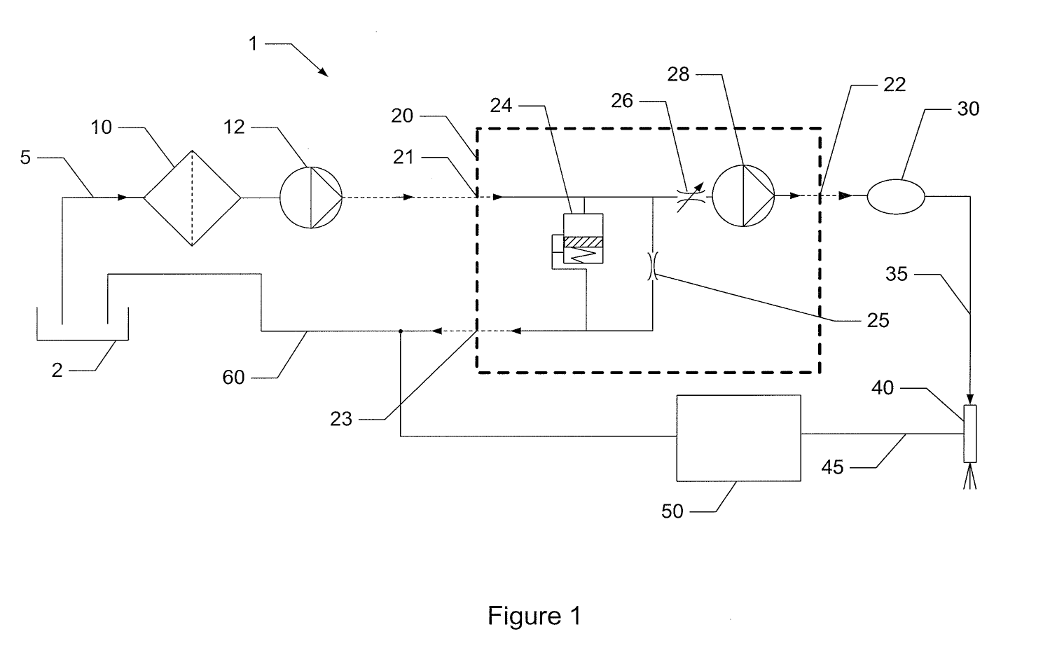

Referring to FIG. 1, the fuel delivery system 1 comprises a fuel supply reservoir 2, a fuel filter 10, a transfer pump 12, a high pressure pump arrangement 20, a common rail accumulator volume 30, a plurality of servo-valve type fuel injectors 40 and pressure regulating means 50.

The fuel filter 10 and transfer pump 12 are disposed within a fuel supply line 5 which connects the fuel supply 2 to an inlet of the high pressure pump arrangement 20. The fuel supply 2 may be a vehicle fuel tank and the fuel may be diesel fuel.

The high pressure fuel pump arrangement 20 comprises an inlet 21, a high pressure outlet 22 and a low pressure outlet 23. The high pressure pump 20 also includes a pump pressure regulator 24, a pumping unit 28, a cooling orifice 25 and a metering valve 26.

As shown schematically in FIG. 1, fuel received at the pump inlet 21 is at a relatively low pressure, typically in the region of 5 bar, as determined by the transfer pump 12 in order that the high pressure pump unit 28 can be charged with fuel efficiently. From the pump inlet 21, fuel at transfer pressure is fed to the pumping unit 28 via the metering valve 26 and thus fuel is pressurised to an injectable pressure level which is much higher than the transfer pressure level. As is known in the art, the injectable pressure level generally varies between approximately 200 and above 2000 bar depending on engine operating conditions.

Fuel at transfer pressure is also fed to an inlet end of the pump pressure regulator 24 and through the cooling orifice 25, which is arranged in parallel with the pump pressure regulator 24. Respective outlet ends of the pump pressure regulator 24 and the cooling orifice 25 are connected to the low pressure outlet 23. The low pressure outlet 23 of the high pressure pump arrangement 20 is connected to a fuel return line 60 for conveying fuel back to the fuel supply 2.

The high pressure outlet 22 of the high pressure pump arrangement 20 is connected to the common rail 30 for supplying fuel at high pressure thereto. The common rail 30 comprises a plurality of outlets, each of which is connected to a respective inlet of one of the plurality of fuel injectors 40 by means of a rail-to-injector pipe 35. In FIG. 1, only a single fuel injector 40 and rail-to-injector pipe 35 are shown for clarity.

As explained previously, servo-valve fuel injectors are generally known in the art. For example, the fuel injector 40 may be of the type described in EP 0647780.

The outlet from the control chamber of the fuel injector 40 is connected to one end of a back-leak passage 45. The other end of the back-leak passage 45 is connected to the pressure regulating means 50, to be described in more detail later. The pressure regulating means 50 is, in turn, connected to the fuel return line 60.

In the fuel delivery system described above with reference to FIG. 1, the pressure regulating means 50 is operable to regulate the pressure in the back-leak passage 45 at a target value which is above atmospheric pressure. Accordingly, the system of FIG. 1 is referred to as one having a positive injector back-leak pressure.

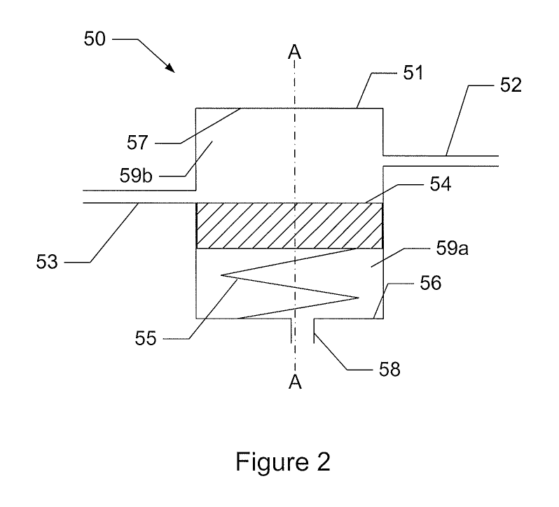

Referring to FIG. 2, a first embodiment of the pressure regulating means 50 is a pressure regulator which comprises a body portion 51 having an inlet 52 which is connected to the back-leak passage 45, and an outlet 53 which is connected to the fuel return line 60. The body portion 51 has the form of a hollow cylinder having a primary axis A-A. A piston 54 is disposed within the body portion 51 for reciprocable movement therein, along the primary axis A-A. Biasing means in the form of a spring 55 is disposed between a first end wall 56 of the body portion 51 and the piston 54. In the case that the pressure regulating means 50 of FIG. 2 is employed in the positive injector back-leak system of FIG. 1, the spring 55 is arranged so as to bias the piston 54 away from the first end wall 56.

It should be noted at this point that although it has been described that the body portion takes the form of a hollow cylinder, this need not be the case and other forms are applicable.

The inlet 52 and the outlet 53 of the pressure regulating means 50 are spaced apart in the direction of the primary axis A-A. More specifically, the outlet 53 is disposed approximately half-way along the body portion 51 in the direction of the primary axis A-A. The inlet 52 is disposed between the outlet 53 and a second end wall 57 of the body portion 51 in the direction of the primary axis A-A, the second end wall 57 being opposite the first end wall 56.

The piston 54 forms a seal with the inner surface of the body portion 51 such that the flow of fluid past the piston 54 in either direction is substantially prevented. The first end wall 56 is provided with an opening 58 which permits air at atmospheric pressure to occupy a first volume 59a, defined between the piston 54 and the first end wall 56. A second volume 59b is defined between the piston 54 and the second end wall 57. In use, the second volume 59b is occupied by fuel from the back-leak passage 45. Accordingly, the fuel pressure in the second volume 59b is equal to the fuel pressure in the back-leak passage 45.

Operation of the fuel delivery system 1 and pressure regulating means 50 described above with reference to FIGS. 1 and 2 will now be explained in detail.

In use, fuel from the fuel supply 2 is fed along the fuel supply line 5, through the fuel filter 10, to the transfer pump 12. The transfer pump 12 supplies relatively low pressure fuel (in the region of 5 bar) to the pump inlet 21 of the high pressure pump arrangement 20.

From the pump inlet 21, fuel is fed to the metering valve 26 which is operable to meter a precise volume of fuel to the high pressure pumping unit 28. The pumping unit 28 pressurises this volume of fuel to a high pressure, e.g. around 2000 bar, and supplies it to the outlet 22 and, thus, to the common rail 30 such that the pressure of the fuel in the common rail 30 is maintained at a desired level.

As explained previously, fuel at transfer pressure is also fed to the inlet of the pump pressure regulator 24 and to the cooling orifice 25, both of which are situated upstream of the metering valve 26 and the pumping unit 28. The pump pressure regulator 24 functions so as to regulate the pressure of the fuel input to the pumping unit 28 in order to maintain it at a set level, for example 5 bar. In the event that the transfer pump 12 over pressurises the fuel, the pump pressure regulator 24 opens so as to spill fuel to the low pressure pump outlet 23 in order to prevent the pump pressure from increasing further. This function ensures that the high pressure pumping unit 28 operates reliably and predictably.

The cooling orifice 25 provides a flow path from the high pressure pump inlet 21, through the cambox of the high pressure pump 20, to the low pressure pump outlet 23. Thus, the flow of fuel through the cambox acts to cool the pump 20 by conducting away the heat generated therein during operation.

Fuel at high pressure in the common rail 30 is fed to the fuel injector 40 via the rail-to-injector pipe 35. The fuel injector 40 is operable between an injecting (or open) state and a non-injecting (or closed) state so as to inject the appropriate amount of fuel into an associated engine combustion chamber in dependence on the fuel demand of the engine. The fuel demand may be determined, for example, by an engine control unit (ECU) in a known manner. As explained previously, the opening and closing of the fuel injector 40 results from the opening and closing of a control valve which, in turn, permits or prevents the flow of fuel out of a control chamber to the back-leak passage 45.

The pressure regulating means 50 acts to maintain the fuel pressure within the back-leak passage 45 at a target pressure value. In the system of FIG. 1, the target value for the pressure in the back-leak passage 45 is above atmospheric pressure. Fuel from the back-leak passage 45 is fed through the inlet 52 of the pressure regulating means 50 and into the second volume 59b. The pressure regulating means 50 is configured such that, when the pressure in the second volume 59b is at the target value, the piston 54 is in the position shown in FIG. 2. That is to say, the target pressure is equal to the pressure required to bias the piston 54 against the combined force of the spring 55 and the force on the piston 54 due to atmospheric pressure in the first volume 59a, such that the outlet 53 is in fluid communication with the second volume 59b. Accordingly, in this position, fuel is permitted to flow out of the second volume 59b, through the outlet 53, along the fuel return line 60 and back to the fuel supply.

If the back-leak pressure drops below the target value, then more fuel will flow out of the second volume 59b than flows in through the inlet 52, causing the fuel pressure in the second volume 59b to be reduced. When this happens, less force is exerted on the piston 54 causing the piston 54 to move towards the second end wall 57. As the piston 54 moves, it covers or closes the outlet 53 thereby reducing and/or preventing the flow of fuel out of the second volume 59b, and reducing the volume of the second volume 59b itself. Accordingly, the fuel pressure in the second volume 59b increases again. As fuel continues to flow into the second volume 59b via the inlet 52, the increase in the pressure in the second volume 59b forces the piston 54 back towards the first end wall 56 thereby opening the outlet 53. Thus, the pressure in the second volume 59b returns to the target value.

With the above-described configuration, the fuel pressure in the second volume 59b of the pressure regulating means 50, and thus the fuel pressure in the back-leak passage 45 can be maintained at or in the region of a target value. The injector back-leak pressure is therefore independent of all product and environmental conditions, with the exception of atmospheric pressure. For example, the injector back-leak pressure can be maintained at a particular target value independent of the changing operational conditions of the engine or any variations due to the manufacturing tolerances of components elsewhere in the system, which may otherwise affect injector performance detrimentally.

Since the first volume 59a of the pressure regulating means 50 is open to atmospheric pressure, by virtue of the opening 58, the target value for the injector back-leak pressure is influenced by fluctuations in atmospheric pressure. More specifically, the force which biases the piston 54 toward the second end wall 57 is a combination of the force of the spring 55 and the force due to atmospheric pressure within the first volume 59a. Accordingly, an increase in atmospheric pressure will lead to a corresponding increase in the target pressure of the back-leak passage 45. Conversely, a lower atmospheric pressure will result in a reduction in the regulated back-leak pressure by a corresponding amount. Notwithstanding the above, it will be appreciated that, in a fuel delivery system with positive injector back-pressure, the greater the target pressure is above atmospheric pressure, the less significant the effects will be upon it due to fluctuations in atmospheric pressure.

By regulating the injector back-leak pressure in the above-described manner, the rate at which fuel flows out of the fuel injector control chamber can be controlled more precisely. Accordingly, during operation of the fuel injector 40, undesirable variations in the quantity of fuel injected during each injection event, i.e. the shot-to-shot variations, are reduced.

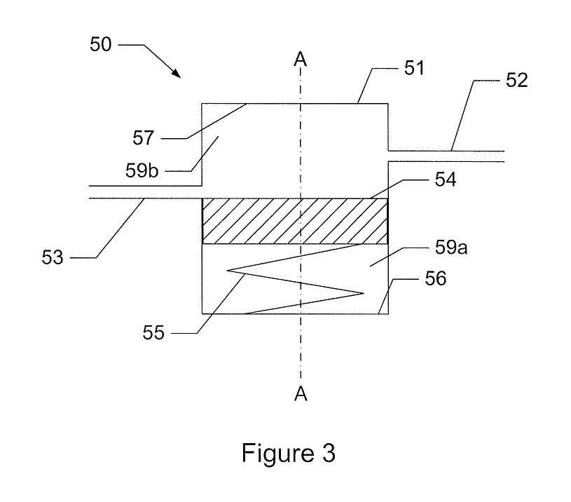

A second embodiment of the pressure regulating means will now be described with reference to FIG. 3. In FIG. 3, like reference numerals refer to like parts of the pressure regulating means 50 described above with reference to FIG. 2.

The second embodiment of the pressure regulating means 50 is a pressure regulator which differs from that of the first embodiment in that the target value for the regulated pressure of fuel in the back-leak passage 45 is independent of atmospheric pressure.

Referring to FIG. 3, in the second embodiment of the pressure regulating means 50 there is no opening 58 in the first end wall 56 of the body portion 51. Instead, the first volume 59a is a sealed chamber defined between the piston 54 and the first end wall 56. As explained previously, the piston 54 forms a seal with the side wall of the body portion 51 which prevents fluid communication between the first and second volumes 59a, 59b.

A reference pressure may therefore be defined as the pressure within the sealed chamber when the piston 54 is in the position shown in FIG. 3. Although, in theory, any pressure may be selected as the reference pressure, by employing the spring 55 in an appropriate configuration, it is preferable that the first volume 59a is evacuated such that the pressure therein is substantially equal to zero, i.e. vacuum. This is because the pressure within a sealed chamber varies with temperature. Accordingly, the closer the pressure in the first volume 59a is to zero, the smaller the variation with temperature will be.

When the pressure in the first volume 59a is zero, the only force biasing the piston 54 toward the second end wall 57 is due to the spring 55. Thus, the target value for the back-leak passage pressure is that pressure which is sufficient to compress the piston 54 against the spring 55 such that the outlet 53 is opened.

As an alternative to evacuating the first volume 59a so as to provide a vacuum, the first volume 59a could be filled with a gas other than air. For example, the first volume 59a may be filled with nitrogen, the pressure of which is less sensitive to temperature changes than air.

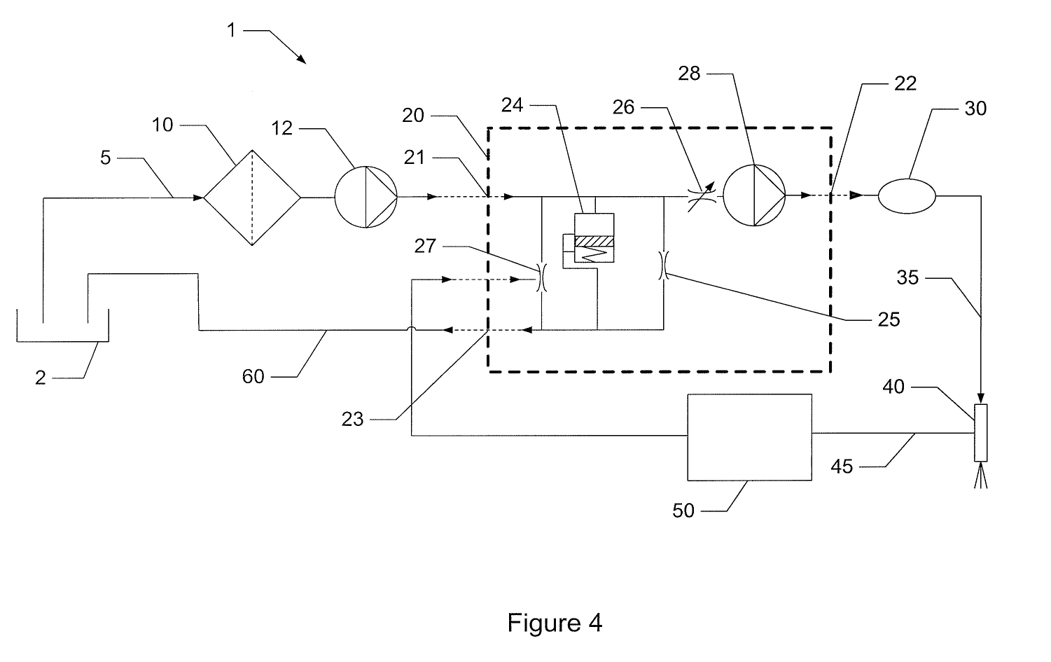

A second embodiment of the fuel delivery system 1 will now be described with reference to FIG. 4, in which like reference numerals refer to like parts of the system described above with reference to FIG. 1.

The second embodiment of the fuel delivery system differs from the first embodiment in that the target value for the regulated pressure of fuel in the back-leak passage 45 is below atmospheric pressure, i.e. negative injector back-leak pressure.

Referring to FIG. 4, the high pressure pump arrangement 20 comprises an additional venturi duct 27 disposed in a flow path which is arranged in parallel with the pump pressure regulator 24 and the cooling orifice 25.

The outlet 53 of the pressure regulating means 50 is coupled to the venturi duct 27 such that the flow of fuel at transfer pressure through the venturi duct 27 to the low pressure outlet 23 of the high pressure pump arrangement 20 causes the pressure in the back-leak passage 45 to be reduced to a target value which is below atmospheric pressure.

The pressure regulating means 50 of either FIG. 2 or FIG. 3 may be employed in the fuel delivery system of FIG. 4. When the atmospheric pressure regulating means of FIG. 2 is used in the fuel delivery system of FIG. 4, the pressure in the second volume 59b is less than the atmospheric pressure in the first volume 59a when the piston 54 is in the position shown in FIG. 2. In this case, the spring 55 is under tension and acts to bias the piston 54 toward the first end wall 56.

In an alternative arrangement (not shown), the spring 55 may be disposed between the piston 54 and the second end wall 57. In this configuration, the spring 55 is in compression and, again, biases the piston 54 toward the first end wall 56 against the force of atmospheric pressure in the first volume 59a.

When the pressure regulating means of FIG. 3 is used in the fuel delivery system of FIG. 4 then, in the case that the reference pressure is zero (i.e. the first volume 59a is fully evacuated), the pressure in the second volume 59b will always be greater than the pressure in the first volume 59a. Accordingly, when the piston 54 is in the position shown in FIG. 3 the spring 55 is in compression and acts to bias the piston 54 toward the second end wall 57.

In an alternative arrangement (not shown), the spring 55 may be disposed between the piston 54 and the second end wall 57. In this configuration, the spring 55 is under tension and, again, biases the piston 54 toward the second end wall 57 against the force of the fuel pressure in the second volume 59b.

In the case that the pressure regulating means of FIG. 3 is filled with a gas other than air, for example a gas having a low coefficient of expansion such as nitrogen, the pressure in the first volume 59a may be greater than the target fuel pressure in the second volume 59b. In this case, the spring 55 will be under tension and will act so as to bias the piston 54 toward the first end wall 56. In an alternative arrangement (not shown), the spring 55 may be disposed between the piston 54 and the second end wall 57. In this configuration, the spring 55 will be in compression and, again, biases the piston 54 toward the second end wall 57 against the reference pressure of the nitrogen in the first volume 59a.

Common to all of the above-described embodiments, whether the target back-leak pressure is positive (FIG. 1 embodiment) or negative (FIG. 4 embodiment) and regardless of the configuration of the pressure regulating means 50, is that when the pressure in the back-leak passage 45 is at the target value, the outlet 53 of the pressure regulating means 50 is open so as to permit the flow of fuel therethrough. In the event that the back-leak pressure falls below the target value, the piston 54 is caused to move so as to close the outlet 53 until the pressure in the second volume 59b, and thus the pressure in the back-leak passage 45 itself, returns to the target value. In this way, the back-leak pressure is maintained at the target value so as to ensure that each of the plurality of fuel injectors 40 injects the required amount of fuel with good repeatability.

In the above-described fuel delivery systems of FIGS. 1 and 4, there may be a single pressure regulating means 50 for regulating the injector back-pressure of a plurality of fuel injectors 40. In this case, each of the plurality of injectors is connected to a common back-leak passage 45 which, in turn, is connected to the inlet of the pressure regulating means 50.

In an alternative arrangement, each fuel injector of a plurality of fuel injectors may be provided with a dedicated pressure regulating means 50. For example, pressure regulating means 50 of the kind described above with reference to FIG. 2 or FIG. 3 may be formed integrally with each fuel injector 40. In this case, the pressure regulating means 50 would be disposed at the outlet of the control chamber, so as to maintain a target pressure value in the back-leak passage 45.

1. A fuel delivery system for an internal combustion engine, the system comprising:
at least one fuel injector, said fuel injector comprising a control chamber having an inlet for receiving high pressure fuel and an outlet enabling fuel to flow out of the control chamber into a back-leak passage associated with the fuel injector, wherein the fuel injector is operable between an injecting state and a non-injecting state in dependence on the fuel pressure within the control chamber, and
pressure regulating means for regulating the fuel pressure within the back-leak passage so as to maintain the injector back-leak pressure at a predetermined target value which is below atmospheric pressure.

2. A system according to claim 1, comprising a high pressure pump arrangement and a common rail accumulator volume, wherein the high pressure pump arrangement is arranged, in use, to pump fuel at high pressure into said common rail, and said common rail is arranged to feed fuel at high pressure to the inlet of said at least one fuel injector; and
wherein said high pressure pump arrangement comprises a venturi duct and said pressure regulating means is coupled to said venturi duct such that, in use, fuel is pumped through the venturi duct to a low pressure pump outlet, thereby reducing the fuel pressure in the back-leak passage below atmospheric pressure.

3. A system according to claim 1, wherein said pressure regulating means comprises:
a hollow body portion having an inlet which is in fluid communication with the back-leak passage, and an outlet; and
a piston arranged for reciprocable movement within said body portion and being sealingly engaged therewith.

4. A system according to claim 3, wherein said pressure regulating means comprises:
a first volume defined between the piston and a first end wall of the body portion; and
a second volume defined between the piston and a second end wall of the body portion;
wherein said outlet is spaced apart from said inlet in the direction of the primary axis (A-A) of the body portion, said inlet being disposed proximal to said second end wall; and
wherein when the pressure in the second volume is less than said target pressure, the piston is biased so as to move toward the second end wall and close the outlet, thereby restricting or preventing the flow of fuel through the outlet.

5. A system according to claim 4, wherein said first end wall comprises an opening so as to enable air at atmospheric pressure into the first volume.

6. A system according to claim 4 where said first volume is evacuated.

7. A system according to claim 4, where said first volume is filled with nitrogen.

8. A system according to claim 4, wherein said pressure regulating means comprises biasing means for imparting a force on the piston in the direction of the primary axis (A-A) of the body portion.

9. A system according to claim 8, wherein said biasing means is disposed between the piston and one of said first end wall and said second end wall.

10. A system according to claim 9, wherein said biasing means is a spring.

11. A system according to claim 1, wherein a pressure regulating means is formed integrally with each of said at least one fuel injectors.

12. A system according to claim 1, comprising at least two fuel injectors, wherein said back-leak passage is associated with each of said at least two fuel injectors.

13. A fuel delivery system for an internal combustion engine, the system comprising:
a high pressure pump arrangement and a common rail accumulator volume, wherein the high pressure pump arrangement is arranged, in use, to pump fuel at high pressure into said common rail;
at least one fuel injector, wherein said common rail is arranged to feed fuel at high pressure to the inlet of said at least one fuel injector, said fuel injector comprising a control chamber having an inlet for receiving high pressure fuel and an outlet enabling fuel to flow out of the control chamber into a back-leak passage associated with the fuel injector, wherein the fuel injector is operable between an injecting state and a non-injecting state in dependence on the fuel pressure within the control chamber, and
a pressure regulator for regulating the fuel pressure within the back-leak passage so as to maintain the injector back-leak pressure at a predetermined target value which is below atmospheric pressure
wherein said high pressure pump arrangement comprises a venturi duct and said pressure regulator is coupled to said venturi duct such that, in use, fuel is pumped through the venturi duct to a low pressure pump outlet, thereby reducing the fuel pressure in the back-leak passage below atmospheric pressure.

14. A method of controlling a fuel injector in a fuel delivery system for an internal combustion engine, the fuel injector comprising a control chamber having an inlet for receiving high pressure fuel and an outlet enabling fuel to flow out of the control chamber into a back-leak passage associated with the fuel injector, the method comprising:
varying the fuel pressure in the control chamber to change a state of the fuel injector between an injecting state and a non-injecting state, and
regulating the fuel pressure within the back-leak passage so as to maintain the injector back-leak pressure at a predetermined target value which is below atmospheric pressure.
